(19) United States
(12) Patent Application Publication
(10) Pub. No.: US 2009/0094016 A1
(43) Pub. Date: Apr. 9, 2009

(54) APPARATUS AND METHOD FOR TRANSLATING WORDS IN IMAGES

(75) Inventor: HUA-JEN MAO, Tu-Cheng (TW)

Correspondence Address: PCE INDUSTRY, INC.;ATT. Steven Reiss, 458 E. LAMBERT ROAD, FULLERTON, CA, 92835, US

(73) Assignee: Chi Mei Communication Systems, Inc., Tu-Cheng City (TW)

(21) Appl. No.: 11/967,033

(22) Filed: Dec. 29, 2007

(30) Foreign Application Priority Data
Oct. 9, 2007 (CN) 200710201983.5

(51) Int. Cl. G06F 17/28

(52) U.S. Cl. 704/3; 704/2

(57) ABSTRACT

A method for translating words in images is provided. The method includes the following steps of: providing a storing unit for storing multiple word libraries, each word library corresponds to a language; providing a translation mode for a user to select; acquiring an image which comprises words to be translated; confirming a language of the words in the image; confirming a desired language for translating the words; transforming a format of the image into a text file; retrieving characters from the text file, and transforming the characters into literal codes; identifying the words in the image by comparing the literal codes with data in the word library corresponding to the confirmed language; and translating the identified words into the desired language, and generating corresponding translation results. A related apparatus is also disclosed.

### BACKGROUND OF THE INVENTION

1. Field of the Invention

The present invention relates to apparatuses and methods for translating words, and particularly to an apparatus and method for translating words in images.

2. Description of Related Art

Nowadays, the intercommunication between the people from different countries becomes more and more frequent and people are faced with a multi-language environment. It is often difficult for people to communicate in a language that they are not familiar with. For example, if a Japanese cannot speak any other language but his native language and goes to Paris, he/she will not be able to recognize street signposts, restaurant menus, etc. Thus, it is inconvenient for people speaking only their native language to travel in foreign countries.

With the development of the technology of optical character recognition, text information in an image may be recognized. However, most optical character recognition systems need to utilize an optical scanner for scanning text into image and then analyzing the image. It is inconvenient to carry such optical scanner when traveling. Furthermore, many objects cannot be scan through the optical scanner, such as the signpost, advertisements, etc.

Accordingly, what is needed is an apparatus and method for translating words in the images and to identify and translate the words, in the images, into a designated language.

### SUMMARY OF THE INVENTION

An apparatus for translating words in images is provided. The apparatus includes a storing unit, an image inputting unit, a word identifying unit, and a translating unit. The storing unit is configured for storing multiple word libraries, each word library corresponding to one language. The image inputting unit is configured for acquiring an image comprising words to be translated, providing a translation mode for a user to select, confirming a language of the words in the image, and confirming a desired language for translating the words. The word identifying unit is configured for transforming a format of the image into a text file, retrieving characters from the text file, transforming the characters into literal codes, and identifying the words in the image by comparing the literal codes with data in the word library corresponding to the confirmed language. The translating unit is configured for translating the identified words from the confirmed language into the desired language, and generating corresponding translation results.

Furthermore, a method for translating words in images is provided. The method includes the following: providing a storing unit for storing multiple word libraries, each word library corresponding to a language; providing a translation mode for a user to select; acquiring an image which comprises words to be translated; confirming a language of the words in the image; confirming a desired language for translating the words; transforming a format of the image into a text file; retrieving characters from the text file, and transforming the characters into literal codes; identifying the words in the image by comparing the literal codes with data in the word library corresponding to the confirmed language; and translating the identified words from the confirmed language into the desired language, and generating corresponding translation results.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic functional block diagram of an apparatus for translating words in images in accordance with a preferred embodiment of the present invention.

FIG. 2 is a schematic diagram illustrating translation interfaces of the preferred embodiment.

FIG. 3 is a flow chart illustrating a method for translating words in images in accordance with the preferred embodiment.

FIG. 4 is a schematic diagram illustrating a data flow for translating words in images in accordance with the preferred embodiment.

### DETAILED DESCRIPTION OF THE INVENTION

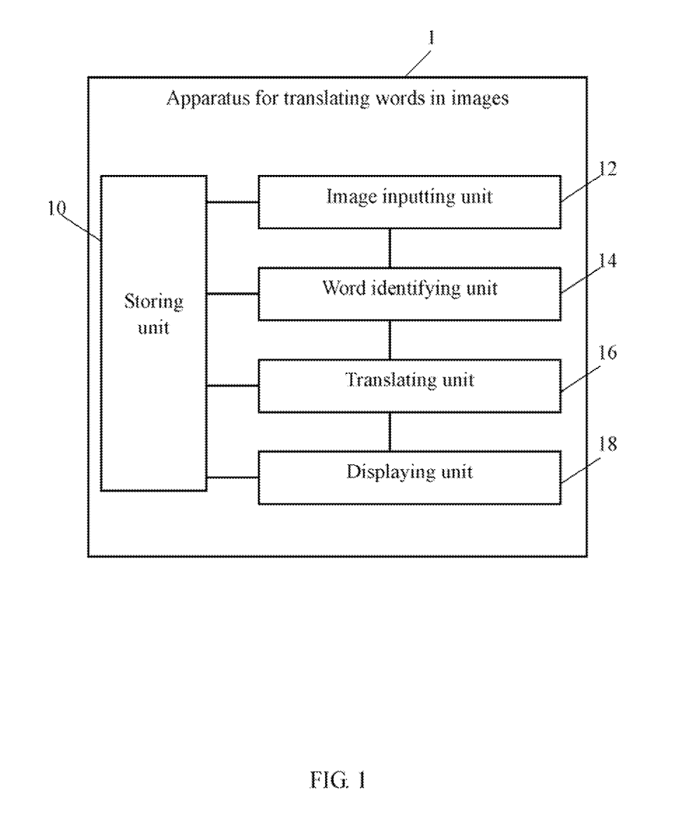

FIG. 1 is a schematic functional block diagram of an apparatus for translating words in images (hereinafter, “the apparatus”) in accordance with a preferred embodiment of the present invention. The apparatus 1 may be installed in various kinds of electronic devices (i.e., a computer), and especially in portable electronic devices, such as mobile phones, digital cameras, digital videos, notebook, Palms, and personal digital assistants (PDAs), and so on. The apparatus 1 provides an interactive user interface for users to perform relevant operations, such as acquiring images, translating words in the images, and viewing translation results, and so on.

The apparatus 1 typically includes a storing unit 10, an image inputting unit 12, a word identifying unit 14, a translating unit 16, and a displaying unit 18.

In the preferred embodiment, the apparatus 1 is installed in a mobile phone (not shown in FIG. 1), which has a camera for capturing images. For example, if a user needs to translate words on an item/object, i.e., a restaurant menu, a street signpost, a book, etc, he/she may utilize the image inputting unit 12 to acquire images including words to be translated by capturing images on the item/object firstly, and then the words in the images may be identified and translated by the word identifying unit 14 and the translating unit 16.

The storing unit 10 may be any kind of storage, such as a flash memory, a hard disk, or any other suitable devices that can store data, and is configured for storing multiple word libraries. Each word library includes a plurality of words in a special language. The word libraries may include, but not limited to, a Chinese word library, an English word library, a symbol library, a French word library, and so on. The word libraries are used for storing literal codes, which can be recognized and processed by processors embedded in the apparatus.

The image inputting unit 12 is configured for acquiring an image including words to be translated, and storing the image into the storing unit 10. In the preferred embodiment, the figure inputting unit 12 is a camera of the mobile phone. In other embodiments, the image inputting unit 12 may be a scanner connected with a computer, or any other devices that can acquire 2D or 3D images. The acquired image may be stored in different formats, such as BMP (bitmap) format, JPEG (Joint Photographic Expert Group) format, GIF (Graphics Interchange Format), PNG (Portable Network Graphic) format, etc. For example, if the user needs to translate some words on an item/object (i.e., the restaurant menu, the street signposts, etc), he/she may capture an image of the item/object through the image inputting unit 10, and then the image is created by the image inputting unit 12.

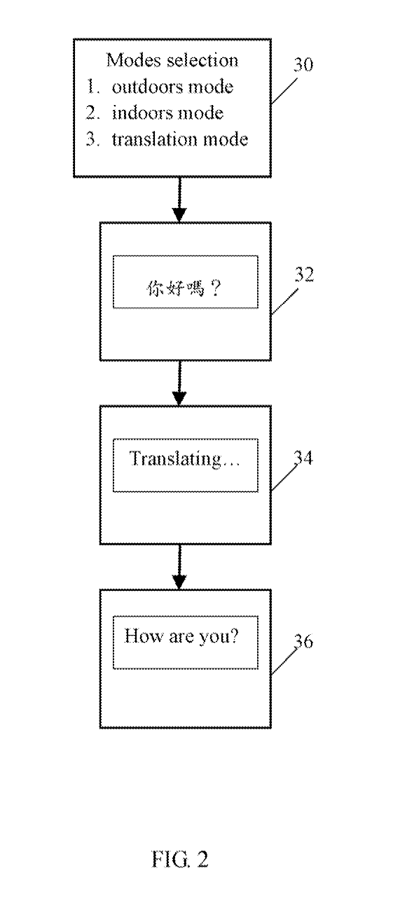

The image inputting unit 12 is also configured for providing multiple image modes to be selected by the user for acquiring the images. As shown in FIG. 2, a modes selection interface 30 provides three image modes of: an outdoor mode, an indoor mode, and a translation mode. If the outdoor mode or the indoor mode is selected, the image inputting unit 12 only acquires the images by capturing images on the item/object, and then stores the images into the storing unit 10. If the translation mode is selected, the image inputting unit 12 not only acquires the images, but also transmits the images to the word identifying unit 14 and the translating unit 16 for further processing. Under different image modes, different resolutions may be defined.

The image inputting unit 12 is further configured for confirming a language of the words in the image, and confirming a desired language for translating the words. The image inputting unit 12 provides multiple languages styles to be selected by the user. The user may select one language of the words in the images and one desired language for translating the words, and then the image inputting unit 12 confirms the user selections. The desired language may be predefined as the user's native language, for example, if the user is an American, the desired language may be predefined as English.

The word identifying unit 14 is configured for transforming a format of the image into a text file, retrieving characters from the text file, transforming the characters into literal codes, and identifying the words in the image by comparing the literal codes with data in the word library corresponding to the confirmed language.

The word identifying unit 14 is further configured for analyzing a format and a layout of the image. For example, the word identifying unit 14 analyzes the layout of the image for confirming an arrangement of the words in the image by ways of: determining whether the words in the image is arranged transversely or upright, and whether the format of the words is a table, an image, or other formats. The above analysis is helpful for arranging the identified words in a sequence.

The translating unit 16 is configured for translating the identified words from the confirmed language into the desired language, and for generating corresponding translation results.

The displaying unit 18 is configured for displaying various data, such as the image, the identified words, and the translation results, etc. The displaying unit 18 may be an LCD (Liquid Crystal Display), an LED (Light-Emitting Diode), or other kinds of display.

The storing unit 10 is further configured for storing various kinds of data, such as the image, the identified words, and the translation results, etc.

For example, if a user wants to translate the words on the street signpost, he/she may utilize the image inputting unit 12 to select a translation mode, acquire an image including the signpost by capturing an image of the signpost, select the language of the street signpost, and select the desired language to be translated. The identifying unit 14 then identifies the words of the street signpost, and the translating unit 16 translates the identified words into the desired language automatically.

FIG. 2 is a schematic diagram illustrating translation interfaces of the preferred embodiment. Before acquiring the images of the items/objects, one image mode needs to be selected through a modes selection interface 30 provided by the image inputting unit 12. On the modes selection interface 30, three image modes are provided: the outdoor mode, the indoor mode, and the translation mode. If the outdoor mode or the indoor mode is selected, the image inputting unit 12 acquires the images of the item/object by capturing images and stores the images into the storing unit 10. If the translation mode is selected, the image inputting unit 12 not only acquires the images and stores the images into the storing unit 10, but also transmits the images to the word identifying unit 14 and the translating unit 16 for further processing (i.e., identifying the words in the images, translating the identified words, etc). In other embodiments, more image modes for acquiring the images can be preset, such as a flash mode, a video mode, an auto mode, etc.

In the preferred embodiment, the translation mode is selected through the modes selection interface 30, the image inputting unit 12 acquires the image including the words to be translated under the translation mode, and then transmits the images to the word identifying unit 14 after confirming the language of the words and the desired language for translating the words. The word identifying unit 14 transforms the format of the image into the text file, retrieves the characters from the text file, transforms the characters into the literal codes, and identifies the words in the image by comparing the literal codes with data in the word library corresponding to the confirmed language. The identified words are shown on an interface 32. For example, the identified words on the interface 32 are Chinese words.

The identified words are transmitted to the translating unit 16 for translating from the confirmed language into the desired language (i.e., English). Then, an interface 34 displays the translation process.

After the translating unit 16 finishing translating the identified words, the translation result is generated and displayed on the interface 36. As shown on an interface 36, the translation result of the identified words (Chinese words) on the interface 32 is “How are you?”.

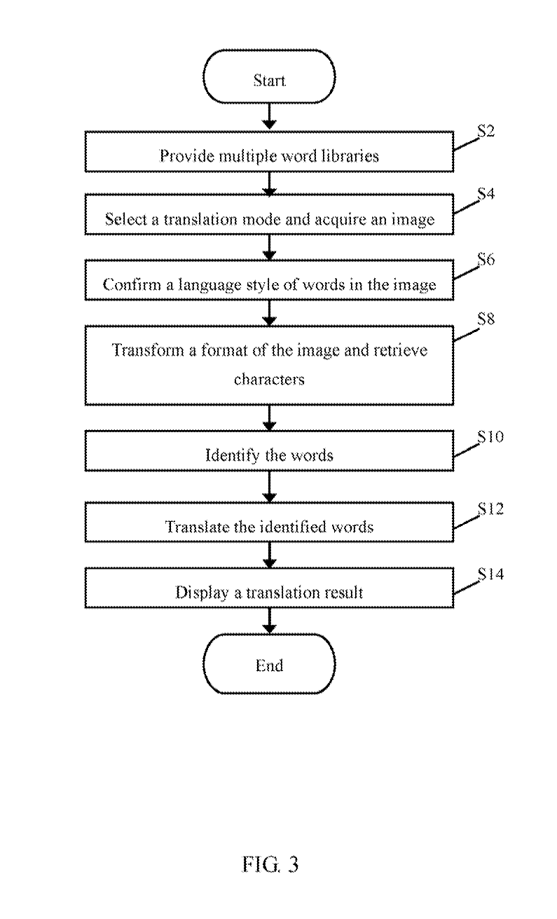

FIG. 3 is a flow chart illustrating a method for translating words in images in accordance with the preferred embodiment. In step S2, the storing unit 10 provides multiple word libraries, wherein each word library corresponds to a language.

In step S4, the translation mode provided by the image inputting unit 12 is selected, and the image inputting unit 12 acquires the image including the words to be translated under the translation mode.

In step S6, the image inputting unit 12 confirms the language of the words in the image, confirms the desired language for translating the words, transmits the image to the word identifying unit 14, and stores the image into the storing unit 10. The image inputting unit 12 provides multiple languages for the user to select one language of the words and one desired language for translation. The desired language for translating the words in the images may be predefined as the user's native language, for example, if the user is an American, the desired language may be predefined as English.

In step S8, the word identifying unit 14 transforms the format of the image into the text file, and retrieves the characters from the text file. The word identifying unit 14 may also analyze the format of the image, such as the BMP format, the JPEG format, etc.

In step S10, the word identifying unit 14 transforms the characters into the literal codes, and identifies the words in the image by comparing the literal codes with the data in the word library corresponding to the confirmed language. The word identifying unit 14 further analyzes the layout of the image by determining whether the words in the image is arranged transversely or upright, and whether the format of the words is the table, the image, or other formats. The analysis of the layout is helpful for arranging the identified words in a sequence.

In step S12, the translating unit 16 translates the identified words from the confirmed language into the desired language, and generates the corresponding translation result.

In step S14, the displaying unit 18 displays the translation result, and the translation result is stored into the storing unit 10.

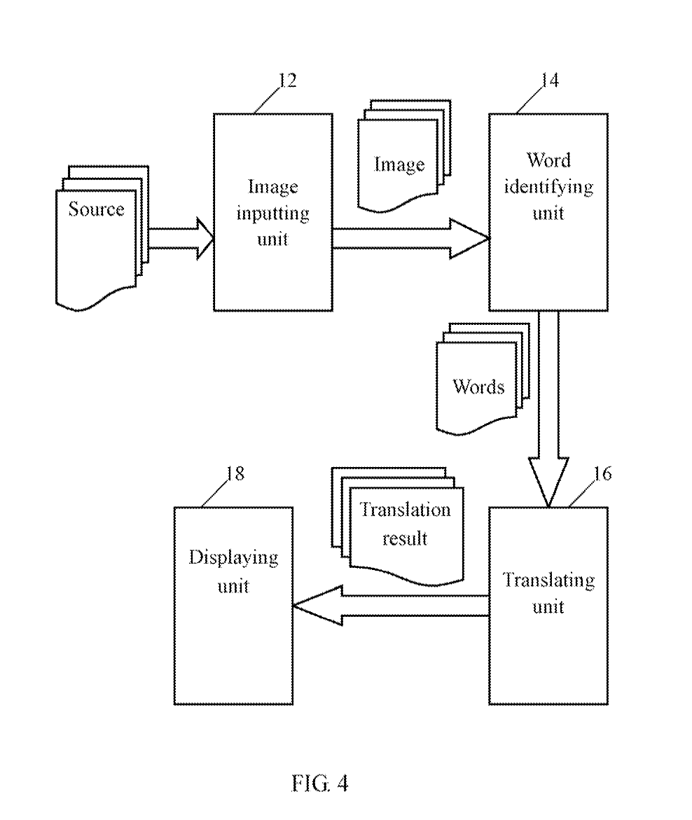

FIG. 4 is a schematic diagram illustrating a data flow for translating words in images in accordance with the preferred embodiment. Firstly, the translation mode provided by the image inputting unit 12 is selected, and then the image inputting unit 12 acquires an image including the words to be translated by means of capturing an image of an object. The object may be anything, such as the signposts, the restaurant menus, the books, business cards, and so on. After acquiring the image, a language of the words and a desired language need to be confirmed according to the user selections.

The word identifying unit 14 analyzes the image from the image inputting unit 12 by ways of: transforming a format of the image into the text file, retrieving the characters from the text file, and transforming the characters into the literal codes. The word identifying unit 14 further identifies the words in the image by comparing the literal codes with the data in the corresponding word library.

The translating unit 16 translates the words identified by the word identifying unit 14 into the confirmed desired language, thereby generating a translation result. Lastly, the displaying unit 18 displays the translation result translated by the translating unit 16.

It should be emphasized that the above-described embodiments, particularly, any “preferred” embodiments, are merely possible examples of implementations, and set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s), and the present invention is protected by the following claims.

What is claimed is:

1. An apparatus for translating words in images, comprising:
a storing unit configured for storing multiple word libraries, each word library corresponding to one language;
an image inputting unit configured for acquiring an image comprising words to be translated, providing a translation mode for a user to select, confirming a language of the words in the image, and confirming a desired language for translating the words;
a word identifying unit configured for transforming a format of the image into a text file, retrieving characters from the text file, transforming the characters into literal codes, and identifying the words in the image by comparing the literal codes with data in the word library corresponding to the confirmed language; and
a translating unit configured for translating the identified words from the confirmed language into the desired language, and generating corresponding translation results.

2. The apparatus as claimed in claim 1, wherein the apparatus further comprises a displaying unit configured for displaying the image, the identified words, and the translation results.

3. The apparatus as claimed in claim 1, wherein the word identifying unit is further configured for analyzing a layout of the image for confirming an arrangement of the words in the image.

4. An electronic method for translating words in images, comprising:
providing a storing unit for storing multiple word libraries, each word library corresponding to a language;
providing a translation mode for a user to select;
acquiring an image which comprises words to be translated;
confirming a language of the words in the image;
confirming a desired language for translating the words;
transforming a format of the image into a text file;
retrieving characters from the text file, and transforming the characters into literal codes;
identifying the words in the image by comparing the literal codes with data in the word library corresponding to the confirmed language; and
translating the identified words from the confirmed language into the desired language, and generating corresponding translation results.

5. The method according to claim 4, further comprising:
displaying the image, the identified words, and the translation results on a display.

6. The method according to claim 4, further comprising:
analyzing a layout of the image for confirming an arrangement of the words in the image.
